(19) United States
(12) Patent Application Publication
(10) Pub. No.: US 2026/0003913 A1
(43) Pub. Date: Jan. 1, 2026

(54) INFORMATION DISPLAY METHOD, STORAGE MEDIUM AND ELECTRONIC DEVICE

(71) Applicant: BOE Technology Group Co., Ltd., Beijing (CN)

(72) Inventors: Naichuan CHEN, Beijing (CN); Zhe ZHANG, Beijing (CN); Kun LI, Beijing (CN); Cunqing LI, Beijing (CN); Sujia JIANG, Beijing (CN); Zhenyan ZHAO, Beijing (CN); Danfeng ZHU, Beijing (CN); Mingyuan MA, Beijing (CN); Binbin CHI, Beijing (CN)

(73) Assignee: BOE Technology Group Co., Ltd., Beijing (CN)

(21) Appl. No.: 19/101,631

(22) PCT Filed: Aug. 21, 2023
(86) PCT No.: PCT/CN2023/114077

§ 371 Date: Feb. 6, 2025

(30) Foreign Application Priority Data
Sep. 28, 2022 (CN) 202211195180.4

(51) Int. Cl. G06F 16/904; G06T 17/00

(52) U.S. Cl. CPC G06F 16/904; G06T 17/00

(57) ABSTRACT

An information display method based on IoT, a storage medium, and an electronic device are provided. The method includes: obtaining collected data of a target IoT device; and generating target information according to the collected data, and sending the target information to terminal devices for display, wherein the terminal devices includes a first terminal device and a second terminal device, the first terminal device runs an application and provides a user interface for the application, and the user interface at least includes a three-dimensional model display area.

### CROSS-REFERENCE TO RELATED APPLICATIONS

The present disclosure is the U.S. national phase application of International Application No. PCT/CN2023/114077 filed on Aug. 21, 2023, which claims priority to Chinese Patent Application No. 202211195180.4, filed on Sep. 28, 2022 and entitled “INFORMATION DISPLAY METHOD AND APPARATUS, STORAGE MEDIUM, AND ELECTRONIC DEVICE”, the entire contents of each are incorporated herein by reference.

### TECHNICAL FIELD

The present disclosure relates to the field of computer technology, in particular, to an information display method based on IoT (Internet of Things), an information display apparatus based on IoT, a computer-readable storage medium, and an electronic device.

### BACKGROUND

With the development of IoT (Internet of Things) technology, more and more regional (a community, a city, etc.) management systems are using the IoT technology to comprehensively collect region information through various collection devices such as cameras and sensors. Artificial intelligence, big data, and other technologies are used to analyze the information collected, and the analysis results are projected into the regional management work, thereby achieving intelligent regional management.

It should be noted that the information disclosed in the above only intends to enhance the understanding of the background of the present disclosure, and thus can include information that does not constitute the prior art already known to those skilled in the art.

### SUMMARY

The present disclosure provides an information display method, including: obtaining collected data of a target IoT device; generating target information based on the collected data and sending the target information to a terminal device for display, wherein the terminal device includes a first terminal device and a second terminal device, the first terminal device runs an application and provides a user interface for the application, and the user interface includes at least a three-dimensional model display area.

The present disclosure provides a computer-readable storage medium on which a computer program is stored, and when the computer program is executed by a processor, any of the methods described in the above are implemented.

The present disclosure provides an electronic device including: a processor; and a memory for storing executable instructions executable by the processor; wherein the processor is configured to execute the executable instructions to cause any of the methods described in the above to be implemented.

It should be understood that the general description in the above and the detailed description in the following are only illustrative and explanatory, and cannot limit the present disclosure.

### BRIEF DESCRIPTION OF THE DRAWINGS

The drawings, which are incorporated in and constitute a portion of this specification, illustrate embodiments consistent with the present disclosure and serve together with the specification to explain principles of the present disclosure. It is apparent that the drawings in the following description are only some embodiments of the present disclosure, and for those of ordinary skill in the art, other drawings can also be obtained from these drawings without creative efforts.

FIG. 1 illustrates a schematic diagram of a system architecture to which an information display method according to embodiments of the present disclosure can be applied;

FIG. 2 schematically illustrates a flowchart of an information display method according to embodiments of the present disclosure;

FIG. 3 schematically illustrates a flowchart of an information display method according to embodiments of the present disclosure;

FIG. 4 schematically illustrates a flowchart of an information display method according to embodiments of the present disclosure;

FIG. 5 schematically illustrates a flowchart of an information display method according to embodiments of the present disclosure;

FIG. 6 schematically illustrates a diagram of a user interface of a first terminal device according to embodiments of the present disclosure;

FIG. 7 schematically illustrates a block diagram of an information display apparatus according to embodiments of the present disclosure; and

FIG. 8 schematically illustrates a structural diagram of an electronic device suitable for implementing embodiments of the present disclosure.

### DETAILED DESCRIPTION

Example embodiments will now be described more comprehensively with reference to the drawings. However, the example embodiments can be implemented in various ways and should not be construed as limited to the embodiments set forth herein. Instead, these embodiments are provided so that the present disclosure will be thorough and complete, and will fully convey the concept of example embodiments to those skilled in the art. The described features, structures, or characteristics can be combined in any suitable manner in one or more embodiments. In the following descriptions, many specific details are provided in order to give a thorough understanding of embodiments of the present disclosure. However, those skilled in the art will realize that the technical solutions of embodiments of the present disclosure can be practiced with one or more of the specific details being omitted, or with other methods, components, devices, steps, etc. being employed. In other cases, well-known technical solutions are not shown or described in detail, so as to avoid obscuring aspects of the present disclosure.

In addition, the drawings are only illustrative diagrams of the present disclosure and are not necessarily drawn to scale. The same reference numerals in the drawings represent the same or similar parts, and thus repeated descriptions of them will be omitted. Some of the block diagrams shown in the drawings are functional entities and may not necessarily correspond to physically or logically independent entities. These functional entities can be implemented in the form of software, in one or more hardware modules or integrated circuits, or in different networks and/or processor devices and/or microcontroller devices.

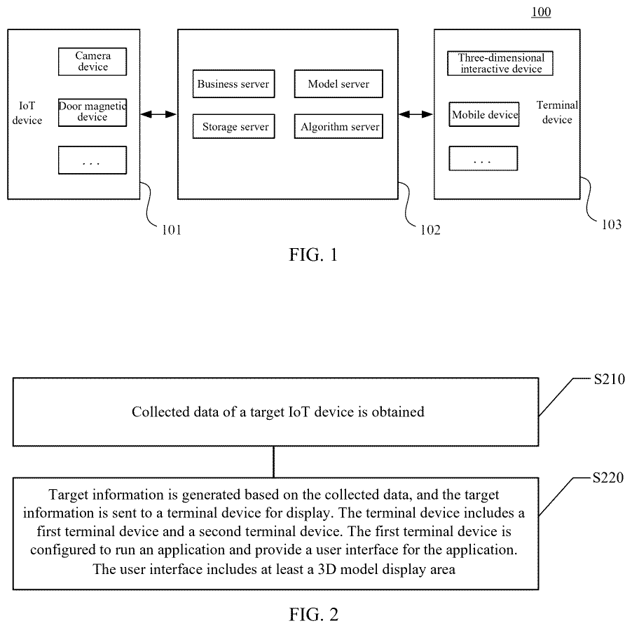

FIG. 1 illustrates a schematic diagram of a system architecture to which an information display method according to embodiments of the present disclosure can be applied.

As shown in FIG. 1, the system architecture 100 can include an IoT device 101, a cloud platform 102, and a terminal device 103. The IoT device 101 can be an IoT terminal collection device or an IoT gateway device. In some embodiments, the IoT terminal collection device can be various types of collection devices such as camera devices and sensors. In some embodiments, the camera device can be a monitoring camera installed in public/fixed regions, and used to collect on-site data in public/fixed regions. The cloud platform 102 includes multiple data processing units such as a business server, a model server, a storage server, and an algorithm server. The terminal device 103 can be a three-dimensional (3D) interactive device, a mobile device, or other electronic devices, including but not limited to a desktop computer, a tablet, etc. The IoT terminal device 101 can interact with the terminal device 103 for data through the cloud platform 102. In some embodiments, the collected data of a target IoT device is obtained, target information is generated based on the collected data, and the target information is sent to the terminal device for display. It should be understood that the number of devices shown in FIG. 1 is only illustrative, and any number of IoT devices 101, cloud platforms 102, and terminal devices 103 can be provided according to needs.

Explanations of technical solutions provided in embodiments of the present disclosure will be described in detail in the following.

Embodiments of the present disclosure provide an information display method based on IoT. As shown in FIG. 2, the information display method can include steps S210 and S220.

Step S210, collected data of a target IoT device is obtained.

Step S220, target information is generated based on the collected data, and the target information is sent to a terminal device for display. The terminal device includes a first terminal device and a second terminal device. The first terminal device is configured to run an application and provide a user interface for the application. The user interface includes at least a 3D model display area.

According to the information display method provided in embodiments of the present disclosure, the collected data is obtained from the target IoT device, the target information is generated based on the collected data, and the target information is sent to the terminal device for display. In some embodiments, the terminal device includes the first terminal device and the second terminal device, the first terminal device is configured to run the application and provide the user interface for the application, and the user interface includes at least the 3D model display area. In this way, the present disclosure can be practiced based on the interconnectivity between the IoT device and the terminal device, so that the real-time data display of multi devices can be achieved.

More detailed explanations of the above steps in embodiments of the present disclosure will be provided in the following.

In step S210, the collected data of the target IoT device is obtained.

In some embodiments of the present disclosure, when community management is carried out in special scenarios, the data exchange can be performed through the IoT device, the cloud platform, and the terminal device, and the data of the devices during the interaction process can be applied to the community management. In such scenario, the IoT device can be a collection device such as a camera device, a door magnetic device, etc. The terminal device can include a first terminal device and a second terminal device. In some embodiments, the first terminal device can be a 3D interactive terminal device with a large screen used by a community administrator, which can run an application and provide a user interface for the application. The user interface can include at least a 3D model display area configured for displaying the 3D model of the current special community. The second terminal device can be a mobile terminal device used by a special community resident. The second terminal device can also run an application and provide a user interface for the application to display information related to the community management. The application run on the second terminal device can be configured for reporting information, processing information, and notifying the special community resident through information broadcasting.

In some embodiments, the 3D model SDK (Software Development Kit) can be pre-installed in the application suitable for the displaying of the 3D interactive terminal device with a large screen, and then the cloud platform can be used to request for the 3D model to be loaded and real-time business data to be pulled. In some embodiments, the 3D model can be mapped using CAD (Computer Aided Design) based on the latitude and longitude coordinates of various areas within the current special community, and the constructed community 3D model can be finely divided into floor rooms. It can be understood that the 3D model SDK can be loaded remotely, alternatively, the 3D model SDK can be stored locally to avoid frequent data requests to the remote end.

In some embodiments, taking an interactive dynamic alarm handling application for the community management as an example, the application is started, and the 3D model of the current special community is loaded to request data. The user interface of the application can include at least a 3D model display area, where the 3D model can be zoomed in or zoomed out through a user gesture operation. The 3D model display area includes multiple functional areas. By triggering operations on different functional areas, functions such as 3D model disassembly, regional thermal map display, and safety path planning can be achieved correspondingly. The user interface of the application can also include a topic switching area for switching between the alarm platform and the 3D model of the current special community. It can be understood that different functional areas can be configured in the user interface of the application according to the actual business needs of the user, and the present disclosure does not make specific limitations on this. According to the embodiments of the present disclosure, the dynamic display of the data can be controlled through gestures such as clicking and dragging, so that the operation can be simpler and more convenient.

In some embodiments, the target IoT device can be multiple camera devices, each of which is used to capture real-time image data of the corresponding region. For example, when a trigger operation on the first functional area in the 3D model display area is received, real-time image data captured by each camera device and position data of the region where each camera device is located are obtained. In some embodiments, each camera device can include all camera devices installed in the current special community, or it can include some camera devices installed in the current special community. For example, when clicking on the first functional area in the 3D model display area, the community manager obtains real-time image data collected by all camera devices in the current special community and the location data of the regions where the camera devices are located. The image data can be the sampled images collected by the corresponding camera device, and the location data of the region where each camera device is located can be the longitude and latitude coordinates of the region where each camera device is located.

The real-time image data collected by each camera device and the location data of the region where each camera device is located can be uploaded to the cloud platform for processing through various data units of the cloud platform, achieving functions such as regional thermal map display and safety path planning, and displaying them in real time to end users through terminal devices.

In step S220, the target information is generated based on the collected data and the target information is sent to the terminal device for display.

When the collected data includes real-time image data collected by each camera device and the location data of the region where each camera device is located, the corresponding target information can be the regional thermal map, prompt information, or path information, etc.

### Example Implementation One

When the target information is the regional thermal map, as shown in FIG. 3, the display function of the regional thermal map can be achieved according to steps S310 to S330.

In step S310, personnel data in each image data is obtained by analyzing real-time image data collected by each camera device.

In some embodiments, the image data can be the sampled image collected by the corresponding camera device. By analyzing each image, the personnel data in each image can be obtained. For example, the queuing image of the community residents are collected through each monitoring camera when the community residents are queuing for sampling, and avatar analysis technology is used to calculate the current number of people queuing in the image.

In step S320, multiple regional thermal points are determined based on the location data of the region where each camera device is located, and values are assigned to the corresponding regional thermal points based on the personnel data, to obtain the thermal values of the regional thermal points.

The position data of the region where each camera device is located is the latitude and longitude coordinates of the region where each camera device is located. For example, a thermal region with a coverage diameter of 100 m can be obtained through proportional conversion based on the three-dimensional model of the current special community. Correspondingly, multiple camera devices in the current special community are located in multiple thermal points in the region, and the position of each thermal point in each area is determined through the latitude and longitude coordinates of the region where each camera device is located.

In step S310, by analyzing the captured images of each camera device, the current number of people queuing at each sampling point can be obtained. Based on the current number of people queuing at each sampling point, values can be assigned to the corresponding thermal points in each region, to obtain the thermal value of each regional thermal point. It can be understood that the sampling points and regional thermal points are in one-to-one correspondence. For example, camera device A, sampling point 1, and regional thermal point 1 are in correspondence, while camera device B, sampling point 2, and regional thermal point 2 are in correspondence. When the captured image of camera device A is analyzed, and when the current queue size of sampling point 1 is 50 people, the thermal value of regional thermal point 1 can be obtained as 50. When the captured image of camera device B is analyzed, and when the current queue size of sampling point 2 is 10 people, the thermal value of regional thermal point 2 can be obtained as 10.

In step S330, the regional thermal map is depicted based on the regional thermal points and the thermal values of the regional thermal points, and the regional thermal map is sent to the first terminal device and/or the second terminal device for display.

After determining the location of each regional thermal point in the thermal region and obtaining the thermal value of each regional thermal point, a regional thermal map can be depicted based on each regional thermal point and the thermal value of each regional thermal point. Then, the regional thermal map can be sent to the 3D interactive large screen terminal device used by community managers and/or mobile terminal devices used by special community residents, and displayed through the application installed on each terminal device.

According to the above embodiments, it is convenient for users to grasp the queuing situation of each sampling point in real time based on the regional thermal map, so that they can flexibly select sampling points with fewer people for sampling, which not only saves the time of the user, but also effectively avoids pushing for sampling, thereby improving the effectiveness of the community management.

### Example Implementation Two

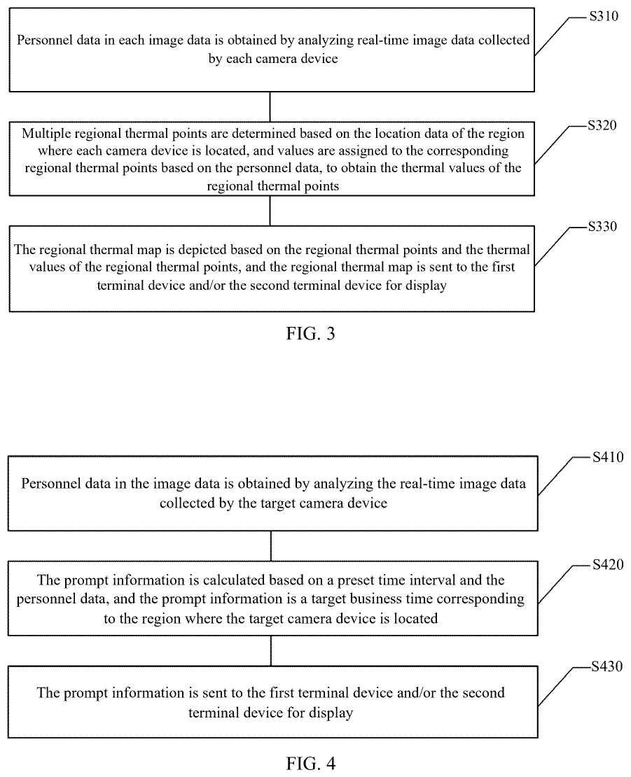

When the target information is the prompt information, as shown in FIG. 4, the display function of the prompt information can be achieved according to steps S410 to S430.

In step S410, personnel data in the image data is obtained by analyzing the real-time image data collected by the target camera device.

In some embodiments, the target camera device can be any camera device installed in the current special community. For example, the avatar analysis is performed on the queuing image of the community residents captured by camera device A during sampling, so as to calculate the current number of people queuing in the image.

In step S420, the prompt information is calculated based on a preset time interval and the personnel data, and the prompt information is a target business time corresponding to the region where the target camera device is located.

In some embodiments, the preset time interval can be a single person sampling time, and the target business time can be a waiting time currently required for the sampling. For example, after the current number of people queuing in the image captured by camera device A is calculated, the waiting time T required for the sampling can be calculated based on the single person sampling time and the current number of queuing people, that is, single person sampling time t*current number n of queuing people.

In step S430, the prompt information is sent to the first terminal device and/or the second terminal device for display.

After the waiting time currently required for the sampling is predicted, the waiting time can be sent to the 3D interactive large screen terminal device used by community managers and/or mobile terminal devices used by special community residents for display. It can be understood that the waiting time currently required for the sampling can be used as a reference for residents in special communities, so as to avoid pushing for sampling, and users do not need to wait for too long, which not only improves the user experience, but also enhances the effectiveness of the community management.

### Example Implementation Three

The target information can also be the path information. In some embodiments, when a trigger operation on the second functional area in the 3D model display area is received, optional region nodes can be determined based on the position data of the region where each camera device is located, the path information can be generated based on the optional region nodes, and the path information can be sent to the first terminal device and/or the second terminal device for display.

In some embodiments, when there is a special management region in the current special community, in order to avoid entering the special management region by mistake, the latitude and longitude coordinates of the region where each camera device is located can be used to determine whether the corresponding region is the special management region. For example, if the region where monitoring camera A is located is not the special management region, then the region where monitoring camera A is located can be used as an optional region node. In some embodiments, multiple optional region nodes within the current special community can be determined, and a real-time path without passing through the special management region can be planned based on the multiple optional region nodes. When the community managers click on the second functional area in the 3D model display area, the real-time path can be displayed on the user interface of the 3D interactive terminal device with a large screen. The special community residents can also query and display the real-time path through the user interface of the mobile terminal devices. In this way, the users can obtain the real-time path that do not pass through the special management region, so as to avoid entering the special management region by mistake, which can also improve the effectiveness of the community management to a certain extent.

### Example Implementation Four

The collected data can be historical user data for a target business, and the target information can be first alarm information. For example, a first-type abnormal user can be determined based on the historical user data of the target business, and the first alarm information can be generated based on the user information of the first-type abnormal user. Then, the first alarm information can be sent to the first terminal device, to display the mapping position of the first-type abnormal user in the 3D model display area based on the first alarm information.

In some embodiments, the target business can be a sampling business, and the corresponding collected data is the historical sampling data of all residents in the current special community. The first-type abnormal user can be a user who did not complete sampling within the preset time period, or a user who completed sampling within the preset time period but had an abnormal sampling detection result. In some embodiments, the preset time period can be the current day, within 3 days, or within 7 days, which is not limited by the present disclosure.

In some embodiments, special community residents who have not completed sampling on the current day and/or special community residents who have completed sampling on the current day but have abnormal sampling detection results can be determined by calling the historical sampling data of all residents in the current special community. The first alarm information can be generated based on the information of the special community residents who have not completed sampling on the current day and/or the special community residents who have completed sampling on the current day but have abnormal sampling detection results. In some embodiments, the first alarm information can include a resident name, a sampling state, and other information. After the first alarm information is generated, the first alarm information can be sent to the three-dimensional interactive terminal device with a large screen used by the community management personnel, to display the information of the personnel who have not completed sampling or have abnormal sampling detection results on the user interface of the three-dimensional interactive terminal device with a large screen. The abnormal personnel can be located by using the backend database and warned on the three-dimensional model of the current special community. For example, a transition animation can be displayed on the three-dimensional model, to display the floor room of the abnormal personnel on the user interface. In some embodiments, a warning and handling function area associated with the first alarm information can also be displayed on the user interface, for example, a voice call function, an abnormal release function, etc.

In some embodiments, it is convenient for the community management personnel to screen for abnormal sampling personnel, and to promptly raise the alarm and handle them, which can improve the efficiency of handling abnormal events in the community management process and thus improve the effectiveness of the community management.

### Example Implementation Five

When the target IoT device is a door magnet device, device information and state information of the door magnet device uploaded through the gateway device in real time can be received. In some embodiments, the door magnetic device can be a door magnetic device that includes a small location module. The door magnetic device can be installed in conjunction with the gateway device on a door of a special community resident. The underlying protocol carried by the door magnetic device enable the door magnetic device to be connected to the cloud platform through the gateway device, and the collected data of the door magnetic device is uploaded to the cloud platform in real time through protocol and data format conversion. In some embodiments, the device information of the door magnetic device can include information such as the location of the door magnetic device, the abnormal time, etc., and the state information of the door magnetic device includes the open or closed state of the door magnetic device.

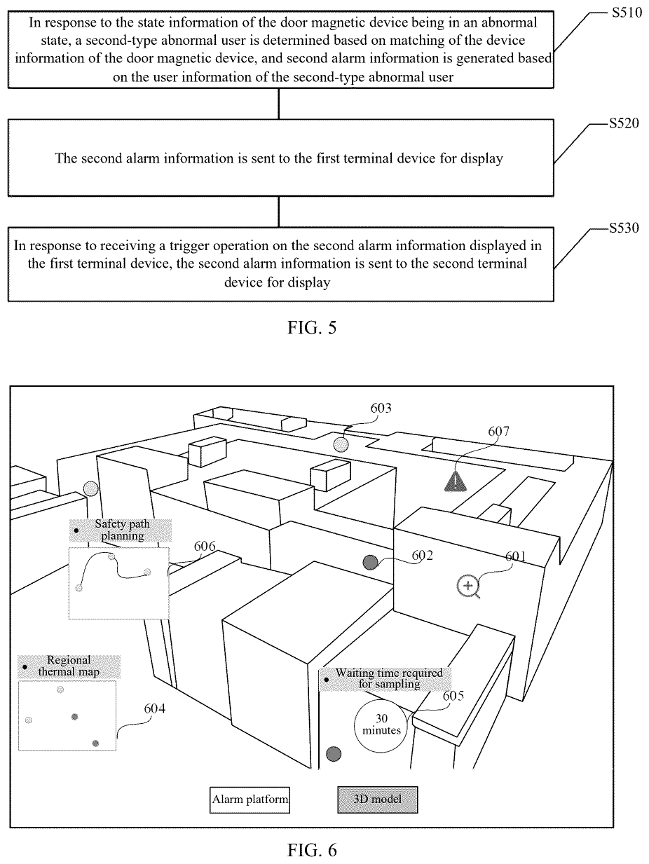

In some embodiments, as shown in FIG. 5, the display function of second alarm information can be achieved according to steps S510 to S530.

In step S510, in response to the state information of the door magnetic device being in an abnormal state, a second-type abnormal user is determined based on matching of the device information of the door magnetic device, and second alarm information is generated based on the user information of the second-type abnormal user.

When the state information of the door magnetic device is in the abnormal state, for example, when the door magnetic device is in an open state, the door magnetic device can send information such as the location and the abnormal time of the door magnetic device to the cloud platform. Through the business server of the cloud platform, the location and the abnormal time of the door magnetic device can be matched with all residents in the current special community to determine the second-type abnormal user. At the same time, the second alarm information can be generated based on the relevant information of the abnormal user. In some embodiments, the second alarm information can include user information such as the name, the age, the floor, and the abnormal time.

In step S520, the second alarm information is sent to the first terminal device for display.

After the second alarm information is generated, the second alarm information can be sent to the three-dimensional interactive terminal device with a large screen used by the community management personnel to display the user information, the floor information, and the abnormal time on the user interface of the three-dimensional interactive terminal device with a large screen, and to give warnings on the user interface. In some embodiments, the second alarm information can be displayed on the user interface in the form of a pop-up window. The community managers can click on the pop-up window to display the user information, the floor information, and the abnormal time on the user interface, and display the room of the resident in the 3D model display area.

In step S530, in response to receiving a trigger operation on the second alarm information displayed in the first terminal device, the second alarm information is sent to the second terminal device for display.

In some embodiments, a warning and handling function area associated with the second alarm information can also be displayed on the user interface, for example, a reminder function, an abnormal release function, etc. When the community administrators click on the reminder function, it can request the cloud platform to call a third-party SMS platform or by means of relevant applications, to send the second alarm information to the second terminal device for display. The end user of the second terminal device can be the abnormal user or the floor manager, etc. The present disclosure does not provide specific limitations on this. After the abnormity of abnormal user is released, the community management personnel can click on the corresponding sleep command on the user interface to send the sleep command to the corresponding door magnetic device, putting the door magnetic device into sleep mode.

As shown in FIG. 6, the user interface of the application diagram is provided. The user can switch between the alarm platform and the 3D model of the special community, and the current displayed user interface is the 3D model display page of the special community. On this page, when users use gestures to bring the 3D model closer, an icon 601 can be displayed at the corresponding position on the page, indicating that the 3D model at that location will be enlarged. Icons 602 and 603 represent sampling points, and their display states represent the number of the queuing people for sampling corresponding to the sampling point. For example, icon 602 is displayed in a darker color, indicating that the current number of the queuing people for sampling at the sampling point is great, while icon 603 is displayed in a lighter color, indicating that the current number of the queuing people for sampling at the sampling point is small. The regional thermal map 604 includes four thermal points, which correspond one-to-one to icons 602, 603, etc. in the 3D model. The users can learn the sampling situation of the special community in real time and intuitively through the regional thermal map. On this page, the sampling waiting time for each sampling point, such as icon 602 and icon 603, can also be displayed in real time, such as icon 605. When the current sampling queue at a sampling point has a large number of people, and if someone goes to the sampling point for sampling, the expected queuing time is 30 minutes. If there are special management buildings included in the special community, the page can also display the preferred paths that do not pass through the special management buildings in real time, such as the paths shown in the safety path planning 606. When a user fails to complete sampling within the specified time or the sampling detection result shows abnormalities, an alarm can be triggered for the user's location in the 3D model. When a user is in an abnormal state while at home, an alarm can also be triggered for the user's location in the 3D model. As shown in icon 607, there is an abnormal situation at this position in the 3D model that needs to be handled in a timely manner.

According to embodiments of the present disclosure, the cloud platform provides connection communication and command control capabilities for IoT devices and terminal devices, achieving state collection and reporting by the IoT devices and remote control by the terminal devices, so that data interaction and disposal can be more accurate and efficient in special scenarios. Moreover, the 3D interactive terminal device with a large screen can display the collected data from multiple IoT devices more intuitively and vividly.

According to the information display method provided in embodiments of the present disclosure, the collected data of the target IoT device is obtained, the target information is generated based on the collected data, and the target information is sent to the terminal device for display. In some embodiments, the terminal device includes a first terminal device and a second terminal device. The first terminal device runs an application and provides a user interface for the application, and the user interface includes at least a three-dimensional model display area. The present disclosure can be practiced based on the interconnectivity between the IoT device and the terminal device, so that the real-time data display of multi devices can be achieved.

It should be noted that although the various steps of the method in the present disclosure are described in a specific order in the drawings, this does not require or imply that these steps must be executed in that specific order, or that all shown steps must be executed to achieve the desired results. Additionally or alternatively, certain steps can be omitted, multiple steps can be merged into one step for execution, and/or one step can be decomposed into multiple steps for execution.

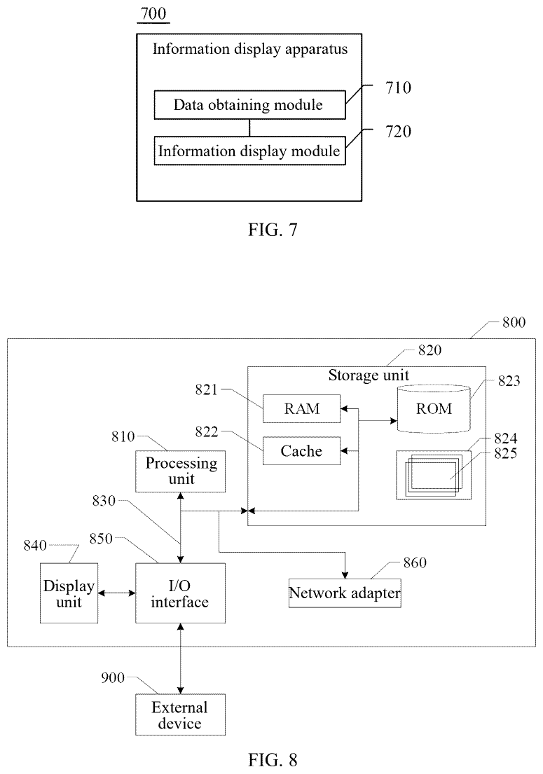

Embodiments of the present disclosure further provide an information display apparatus based on IoT. As shown in FIG. 7, the information display apparatus 700 can include a data obtaining module 710 and an information display module 720.

The data obtaining module 710 is configured to obtain collected data of a target IoT device.

The information display module 720 is configured to generate target information based on the collected data and send the target information to a terminal device for display. The terminal device includes a first terminal device and a second terminal device, the first terminal device runs an application and provides a user interface for the application, and the user interface includes at least a three-dimensional model display area.

In some embodiments, the target IoT device includes multiple camera devices. The data obtaining module 710 is configured to obtain, in response to receiving a trigger operation on a first functional area in the 3D model display area, real-time image data collected by each camera device and position data of a region where each camera device is located.

In some embodiments, the target information is a regional thermal map. The information display module 720 includes an image data analysis module, a thermal value determination module, and a thermal map display module.

The image data analysis module is configured to analyze the real-time image data collected by each camera device and obtain personnel data in each image data.

The thermal value determination module is configured to determine multiple regional thermal points based on the position data of the region where each camera device is located, and assign values to the multiple regional thermal points based on the personnel data to obtain thermal values of the regional thermal points.

The thermal map display module is configured to depict the regional thermal map based on the regional thermal points and the thermal values of the regional thermal points, and send the regional thermal map to the first terminal device and/or the second terminal device for display.

In some embodiments, the target information includes prompt information. The information display module 720 includes an image data analysis module, a prompt information generation module, and a prompt information display module.

The image data analysis module is configured to analyze the real-time image data collected by the target camera device and obtain personnel data in the image data.

The prompt information generation module is configured to calculate the prompt information based on a preset time interval and the personnel data. The prompt information is a target business time corresponding to a region where the target camera device is located.

The prompt information display module is configured to send the prompt information to the first terminal device and/or the second terminal device for display.

In some embodiments, the target information includes path information. The information display module 720 includes an optional area determination module, and a path information display module.

The optional area determination module is configured to determine, in response to receiving a trigger operation on a second functional area in the 3D model display area, optional region nodes based on the position data of the region where each camera device is located.

The path information display module is configured to generate the path information based on the optional region nodes and send the path information to the first terminal device and/or the second terminal device for display.

In some embodiments, the collected data is historical user data for the target business, and the target information includes first alarm information. The information display module 720 includes a first alarm information generation module, and a first alarm information display module.

The first alarm information generation module is configured to determine a first-type abnormal user based on the historical user data for the target business, and generate the first alarm information based on user information of the first-type abnormal user.

The first alarm information display module is configured to send the first alarm information to the first terminal device, to display, based on the first alarm information, a mapping position of the first-type abnormal user in the 3D model display area.

In some embodiments, the target IoT device is a gate magnetic device. The data obtaining module 710 is configured to receive device information and state information of the door magnetic device, and the device information and the state information is uploaded by the door magnetic device through a gateway device in real time.

In some embodiments, the target information includes second alarm information. The information display module 720 includes a second alarm information generation module, and a second alarm information display module.

The second alarm information generation module is configured to determine, in response to the state information of the door magnetic device being in an abnormal state, a second-type abnormal user based on matching of the device information of the door magnetic device, and generate the second alarm information based on user information of the second-type abnormal user.

The second alarm information display module is configured to send the second alarm information to the first terminal device for display; and in response to receiving a triggering operation on the second alarm information displayed in the first terminal device, send the second alarm information to the second terminal device for display.

The specific details of each module in the above information display apparatus have been described in detail in the corresponding information display methods, and thus will not be repeated here.

The modules in the above apparatus can be general-purpose processors, including central processing units, network processors, etc. The modules in the above apparatus can also be digital signal processors, application specific integrated circuits, field programmable gate arrays or other programmable logic devices, discrete gates or transistor logic devices, or discrete hardware components. Each module can also be implemented in software, firmware, and other forms. The processors in the above apparatus can be independent or integrated together.

Embodiments of the present disclosure further provide a computer-readable storage medium on which program products capable of implementing the methods described in the specification are stored. In some embodiments, various aspects of the present disclosure can also be implemented in the form of a program product, which includes program codes used to cause an electronic device to perform the steps described in the “method embodiments” in the specification according to various embodiments of the present disclosure when the program product is running on the electronic device. The program product can be in the form of a portable compact disc read-only memory (CD-ROM) and includes program codes, and can run on the electronic device such as personal computers. However, the program products disclosed herein are not limited to this. In the present disclosure, the readable storage medium can be any tangible medium that contains or stores a program, which can be used by or in combination with an instruction execution system, an apparatus, or a device.

Program products can be any combination of one or more readable media. The readable medium can be a readable signal medium or a readable storage medium. The readable storage medium can be, but is not limited to, systems, apparatus or devices of electricity, magnetism, light, electromagnetism, infrared, or semiconductors, or any combination thereof. More specific examples of readable storage media (non-exhaustive list) include: electrical connections with one or more wires, portable disks, hard drives, random access memory (RAM), read-only memory (ROM), erasable programmable read-only memory (EPROM or flash), optical fibers, portable compact disk read-only memory (CD-ROM), optical storage devices, magnetic storage devices, or any suitable combination of the above.

The computer readable signal media can include data signals propagated in the baseband or as part of the carrier wave, which carry readable program code. This type of transmitted data signal can be in various forms, including but not limited to electromagnetic signals, optical signals, or any suitable combination of the above. The readable signal medium can also be any readable medium other than a readable storage medium, which can send, deliver, or transmit programs for use by or in combination with instruction execution systems, apparatus, or devices.

The program code contained on the readable medium can be transmitted using any appropriate medium, including but not limited to wireless, wired, fiber optic, RF, etc., or any suitable combination of the above.

The program codes for executing the disclosed operations can be written in any combination of one or more programming languages, including object-oriented programming languages such as Java, C++, and conventional procedural programming languages such as C or similar programming languages. The program codes can be completely executed on user computing devices, partially executed on user devices, executed as an independent software package, partially executed on user computing devices, partially executed on remote computing devices, or completely executed on remote computing devices or servers. In the case where remote computing devices are involved, remote computing devices can be connected to user computing devices through any type of network, including local area networks (LAN) or wide area networks (WAN), or can be connected to external computing devices (such as being connected via the Internet provided by the internet service providers).

Embodiments of the present disclosure further provide an electronic device capable of implementing the above methods. An electronic device 800 of such embodiments will be described in the following with reference to FIG. 8. The electronic device 800 shown in FIG. 8 is only an example and should not impose any limitations on the functionality and the use scope of embodiments of the present disclosure.

As shown in FIG. 8, the electronic device 800 can be represented in the form of a general-purpose computing device. The components of electronic device 800 can include but are not limited to: at least one processing unit 810, at least one storage unit 820, a bus 830 connecting different system components (including the storage unit 820 and the processing unit 810), and a display unit 840.

The storage unit 820 stores program codes, which can be executed by the processing unit 810 to implement the steps according to various exemplary embodiments of the present disclosure described in the “method embodiments” in the specification. For example, the processing unit 810 can perform any one or more method steps in FIGS. 2 to 5.

The storage unit 820 can include a readable medium in the form of a volatile storage unit, such as a random access storage unit (RAM) 821 and/or a cache 822, and can further include a read-only storage unit (ROM) 823.

The storage unit 820 can further include a program/utility 824 with a set (at least one) of program modules 825, such program modules 825 including but not limited to: operating systems, one or more applications, other program modules, and program data, each of which may include an implementation of a network environment.

The bus 830 can represent one or more types of bus structures, including storage unit buses or storage unit controllers, peripheral buses, graphics acceleration ports, processing units, or local area buses using any of the multiple bus structures.

The electronic device 800 can also communicate with one or more external devices 900 (such as keyboards, pointing devices, Bluetooth devices, etc.), and can also communicate with one or more devices that enable users to interact with the electronic device 800, and/or with any device that enables the electronic device 800 to communicate with one or more other computing devices (such as routers, modems, etc.). Such communication can be carried out through an input/output (I/O) interface 850. Moreover, the electronic device 800 can also communicate with one or more networks (such as local area networks (LAN), wide area networks (WAN), and/or public networks, such as the Internet) through the network adapter 860. As shown in FIG. 8, the network adapter 860 communicates with other modules of electronic device 800 through the bus 830. It should be understood that although not shown in FIG. 8, other hardware and/or software modules can be used in conjunction with the electronic device 800, including but not limited to: microcode, device drivers, redundant processing units, external disk drive arrays, RAID systems, tape drives, and data backup storage systems.

Through the description of the above method embodiments, it is easy for those skilled in the art to understand the present disclosure. The method embodiments described herein can be implemented through software or by combining software with necessary hardware. Therefore, the technical solutions according to the embodiments of the present disclosure can be embodied in the form of a software product, which can be stored on a non-volatile storage medium (such as CD-ROM, USB drive, portable hard drive, etc.) or on a network, including several instructions to enable a computing device (such as a personal computer, a server, a terminal device, or a network device, etc.) to execute the method according to the embodiments of the present disclosure.

In addition, the above drawings are only illustrative explanations of the processing included in the methods according to the embodiments of the present disclosure, and are not intended to a limit purpose. It is easy to understand that the processing shown in the above figures does not indicate or limit the temporal order of these processing. Additionally, it is also easy to understand that these processing can be executed synchronously or asynchronously, for example, across multiple modules.

It should be noted that although several modules or units of the device used for action execution are mentioned in the above detailed description, and this division is not mandatory. In fact, according to the embodiments of the present disclosure, the features and functions of two or more modules or units described in the above can be concretized within one module or unit. On the contrary, the features and functions of a module or unit described in the above can be further divided into multiple modules or units to concretize.

It should be understood that the present disclosure is not limited to the precise structure described in the above and shown in the drawings, and various modifications and changes can be made without departing from its scope. The scope of the present disclosure is limited only by the appended claims.

1. An:
information display method based on Internet of Things (IoT), characterized by comprising:
obtaining collected data of a target IoT device;
generating target information based on the collected data and sending the target information to a terminal device for display, wherein the terminal device comprises a first terminal device and a second terminal device, the first terminal device runs an application and provides a user interface for the application, and the user interface comprises at least a three-dimensional (3D) model display area.

2. The information display method according to claim 1, wherein the target IoT device comprises multiple camera devices, and obtaining the collected data of the target IoT device, comprises:
obtaining, in response to receiving a trigger operation on a first functional area in the 3D model display area, real-time image data collected by each camera device and position data of a region where each camera device is located.

3. The information display method according to claim 2, wherein the target information comprises a regional thermal map, and generating the target information based on the collected data and sending the target information to the terminal device for display, comprises:
obtaining personnel data in the image data by analyzing the real-time image data collected by each camera device;
determining multiple regional thermal points based on the position data of the region where each camera device is located, and assigning values to the multiple regional thermal points based on the personnel data to obtain thermal values of the regional thermal points; and
depicting the regional thermal map based on the regional thermal points and the thermal values of the regional thermal points, and sending the regional thermal map to the first terminal device and/or the second terminal device for display.

4. The information display method according to claim 2, wherein the target information comprises prompt information, and generating the target information based on the collected data and sending the target information to the terminal device for display, comprises:
obtaining personnel data in the image data by analyzing the real-time image data collected by a target camera device;
calculating the prompt information based on a preset time interval and the personnel data, wherein the prompt information comprises a target business time corresponding to a region where the target camera device is located; and
sending the prompt information to the first terminal device and/or the second terminal device for display.

5. The information display method according to claim 2, wherein the target information comprises path information, and generating the target information based on the collected data and sending the target information to the terminal device for display, comprises:
determining, in response to receiving a trigger operation on a second functional area in the 3D model display area, optional region nodes based on the position data of the region where each camera device is located; and
generating the path information based on the optional region nodes and sending the path information to the first terminal device and/or the second terminal device for display.

6. The information display method according to claim 1, wherein the collected data comprises historical user data for a target business, the target information comprises first alarm information, and generating the target information based on the collected data and sending the target information to the terminal device for display, comprises:
determining a first-type abnormal user based on the historical user data for the target business, and generating the first alarm information based on user information of the first-type abnormal user; and
sending the first alarm information to the first terminal device, to display, based on the first alarm information, a mapping position of the first-type abnormal user in the 3D model display area.

7. The information display method according to claim 1, wherein the target IoT device comprises a gate magnetic device, and obtaining the collected data of the target IoT device, comprises:
receiving device information and state information of the door magnetic device, wherein the device information and the state information is uploaded by the door magnetic device through a gateway device in real time.

8. The information display method according to claim 7, wherein the target information comprises second alarm information, and generating the target information based on the collected data and sending the target information to the terminal device for display, comprises:
determining, in response to the state information of the door magnetic device being in an abnormal state, a second-type abnormal user based on matching of the device information of the door magnetic device, and generating the second alarm information based on user information of the second-type abnormal user;
sending the second alarm information to the first terminal device for display; and
sending, in response to receiving a triggering operation on the second alarm information displayed in the first terminal device, the second alarm information to the second terminal device for display.

9. (canceled)

10. A non-transitory computer-readable storage medium having a computer program stored thereon, which when executed by a processor, causes the method according to claim 1 to be performed.

11. An electronic device, comprising:
a processor; and
a memory for storing executable instructions executable by the processor;
wherein the processor is configured to:
obtain collected data of a target Internet of Things (IoT) device;
generate target information based on the collected data and sending the target information to a terminal device for display, wherein the terminal device comprises a first terminal device and a second terminal device, the first terminal device runs an application and provides a user interface for the application, and the user interface comprises at least a three-dimensional (3D) model display area.

12. The electronic device according to claim 11, wherein the processor is further configured to:
obtain, in response to receiving a trigger operation on a first functional area in the 3D model display area, real-time image data collected by each camera device and position data of a region where each camera device is located.

13. The electronic device according to claim 12, wherein the target information comprises a regional thermal map, and the processor is further configured to:
obtain personnel data in the image data by analyzing the real-time image data collected by each camera device;
determine multiple regional thermal points based on the position data of the region where each camera device is located, and assign values to the multiple regional thermal points based on the personnel data to obtain thermal values of the regional thermal points; and
depict the regional thermal map based on the regional thermal points and the thermal values of the regional thermal points, and send the regional thermal map to the first terminal device and/or the second terminal device for display.

14. The electronic device according to claim 12, wherein the target information comprises prompt information, and the processor is further configured to:
obtain personnel data in the image data by analyzing the real-time image data collected by a target camera device;
calculate the prompt information based on a preset time interval and the personnel data, wherein the prompt information comprises a target business time corresponding to a region where the target camera device is located; and
send the prompt information to the first terminal device and/or the second terminal device for display.

15. The electronic device according to claim 12, wherein the target information comprises path information, and the processor is further configured to:
determine, in response to receiving a trigger operation on a second functional area in the 3D model display area, optional region nodes based on the position data of the region where each camera device is located; and
generate the path information based on the optional region nodes and send the path information to the first terminal device and/or the second terminal device for display.

16. The electronic device according to claim 11, wherein the collected data comprises historical user data for a target business, the target information comprises first alarm information, and the processor is further configured to:
determine a first-type abnormal user based on the historical user data for the target business, and generate the first alarm information based on user information of the first-type abnormal user; and
send the first alarm information to the first terminal device, to display, based on the first alarm information, a mapping position of the first-type abnormal user in the 3D model display area.

17. The electronic device according to claim 11, wherein the target IoT device comprises a gate magnetic device, and the processor is further configured to:
receive device information and state information of the door magnetic device, wherein the device information and the state information is uploaded by the door magnetic device through a gateway device in real time.

18. The electronic device according to claim 17, wherein the target information comprises second alarm information, and the processor is further configured to:
determine, in response to the state information of the door magnetic device being in an abnormal state, a second-type abnormal user based on matching of the device information of the door magnetic device, and generate the second alarm information based on user information of the second-type abnormal user;
send the second alarm information to the first terminal device for display; and
send, in response to receiving a triggering operation on the second alarm information displayed in the first terminal device, the second alarm information to the second terminal device for display.
